(19) United States
(12) Patent Application Publication
(10) Pub. No.: US 2008/0113225 A1
(43) Pub. Date: May 15, 2008

(54) Perpendicular magnetic recording medium and method for manufacturing the same

(75) Inventors: Kiwamu Tanahashi, Tokyo (JP); Yoshibumi Matsuda, Kanagawa (JP); Mineaki Kodama, Kanagawa (JP); Koji Sakamoto, Kanagawa (JP); Tomoo Yamamoto, Kanagawa (JP); Joe Inagaki, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Inc., Amsterdam (NL)

(21) Appl. No.: 11/983,576

(22) Filed: Nov. 9, 2007

(30) Foreign Application Priority Data
Nov. 10, 2006 (JP) 2006-305745

(51) Int. Cl. G11B 5/66; G11B 5/84

(52) U.S. Cl. 428/830; 427/599

(57) ABSTRACT

Fluctuation of read/write characteristics during mass production is suppressed for a perpendicular magnetic recording medium having a perpendicular recording layer of a bi-layered structure, in which a first Co—Cr—Pt alloy magnetic layer containing an oxide and a second Co—Cr—Pt magnetic layer are formed successively. According to one embodiment, in a perpendicular magnetic recording medium, an adhesion layer, a soft magnetic underlayer, a seed layer, an intermediate layer, a perpendicular recording layer, a protective layer, and a lubricating layer are successively formed on a substrate. The perpendicular recording layer has a bi-layered structure in which a first Co—Cr—Pt alloy magnetic layer containing an oxide and a second Co—Cr—Pt alloy magnetic layer containing a marker element for measurement of a thickness selected from Mo, Mn, and V are successively formed, and the content of the marker element for measurement of thickness is about 1.5 at % or more and about 5 at % or less.

### CROSS-REFERENCES TO RELATED APPLICATIONS

The instant nonprovisional patent application claims priority to Japanese Patent Application No. 2006-305745 filed Nov. 10, 2006 and which is incorporated by reference in its entirety herein for all purposes.

### BACKGROUND OF THE INVENTION

In recent years, magnetic disk apparatus have been incorporated in home information electronics products as well as personal computers, and a demand for the reduction of size and the increase of capacity has been increased more and more. Meanwhile, as the areal recording density of the magnetic disk apparatus increases, and the recording bit size is made finer, a problem known as “thermal decay” where magnetically recorded data are erased after several years due to the heat at the surrounding environment, has become apparent. Accordingly, it has been considered difficult to attain an areal recording density in excess of 100 Giga bits per square inch in the conventional longitudinal recording system.

On the other hand, the perpendicular recording system, different from the longitudinal recording system, has a characteristic that the demagnetization field exerting between adjacent bits decreases as the linear recording density increases to keep the recorded magnetization stable. Further, since a stronger head magnetic field is obtained by employing a soft magnetic underlayer having a high permeability under a perpendicular recording layer, the coersivity of the perpendicular recording layer can be increased. With the reason described above, it is considered that the perpendicular recording system is one of the effective means for overcoming the limit caused by thermal decay of the longitudinal recording system.

A medium used in the perpendicular recording system mainly comprises a soft magnetic underlayer assisting a recording head, and a perpendicular recording layer for recording and possessing magnetic information. For the perpendicular recording layer, it is desirable to use a material having a strong perpendicular magnetic anisotropy so that recording magnetization is arranged in the direction perpendicular to the film surface, and in which each of magnetic particles are magnetically isolated so as to improve the medium S/N. Specifically, granular type materials comprising Co—Cr—Pt series alloys with addition of oxides such as SiO₂ have been studied generally. In such granular type perpendicular recording layer, since non-magnetic oxides form grain boundaries so as to surround the magnetic particles, magnetic interaction between adjacent magnetic particles is decreased. Further, since the grain boundaries of the oxide suppress coalescence of the magnetic particles, it has a feature capable of decreasing the dispersion of the particles size compared with conventional Cr-segregation type longitudinal recording media. The perpendicular recording medium having such a fine structure has high medium S/N and excellent thermal stability and has a possibility of greatly contributing to the improvement of the areal recording density.

However, in a case where the magnetic interaction between the adjacent magnetic particles is decreased greatly, individual magnetic particles independently tend to reverse, thereby increasing the dispersion of the reversal magnetic field. As a result, sufficient data writing becomes difficult. On the other hand, for the recording head, studies have been done for the head having a trailing shield in order to improve the magnetic flux gradient and improve the recording resolution. In the recording head of this type, the recording magnetic field strength tends to decrease compared with conventional single pole head. Under such a situation, it has become important for the perpendicular magnetic recording medium to improve write-ability while possessing high medium SNR and excellent thermal stability.

In view of such a demand for the perpendicular magnetic recording medium, for example, Japanese Patent Publication No. 2004-310910 (“Patent Document 1”) proposes a medium using two or more magnetic layers for a perpendicular magnetic layer in which at least one layer contains Co as a main ingredient and contains Pt and an oxide, and at least another layer contains Co as a main ingredient and contains Cr and dose not contain an oxide. With such a layer constitution of the perpendicular magnetic layer, it is possible to obtain a medium capable of promoting refinement and magnetic isolation of magnetic particles, capable of greatly improving the signal/noise ratio during reading, capable of improving the thermal fluctuation resistance by the improvement of the reverse magnetic domain nuclei forming field (-Hn), and further having excellent recording characteristics.

### BRIEF SUMMARY OF THE INVENTION

Embodiments in accordance with the present invention suppress fluctuation of read/write characteristics during mass production for a perpendicular magnetic recording medium having a perpendicular recording layer of a bi-layered structure in which a first Co—Cr—Pt alloy magnetic layer containing an oxide and a second Co—Cr—Pt magnetic layer are formed successively. According to the particular embodiment of FIG. 1, in a perpendicular magnetic recording medium, an adhesion layer 11, a soft magnetic underlayer 12, a seed layer 13, an intermediate layer 14, a perpendicular recording layer 15 (15a, 15b), a protective layer 16, and a lubricating layer 17 are successively formed on a substrate 10. The perpendicular recording layer has a bi-layered structure in which a first Co—Cr—Pt alloy magnetic layer 15a containing an oxide and a second Co—Cr—Pt alloy magnetic layer 15b containing a marker element for measurement of a thickness selected from Mo, Mn, and V are successively formed, and the content of the marker element for measurement of thickness is 1.5 at % or more and 5 at % or less.

### BRIEF DESCRIPTION OF THE DRAWINGS

FIG. 1 is a view showing the layer constitution of a perpendicular magnetic recording medium according to a first embodiment of the present invention.

FIG. 2 is a view showing compositions of sputtering targets used for forming respective layers of a perpendicular magnetic recording medium according to the first embodiment.

FIGS. 3(a) and 3(b) are graphs showing the magnetic characteristic of a perpendicular recording layer in a perpendicular magnetic recording medium according to the first embodiment.

FIGS. 4(a)-4(c) are graphs showing the writing/reading characteristic of a perpendicular magnetic recording medium according to the first embodiment

FIG. 5 is a graph showing the result of evaluating the thickness of a second magnetic layer by a fluorescence X-ray method in a perpendicular magnetic recording medium according to the first embodiment.

FIG. 6 is a view showing the result of evaluating the reproducibility for the measurement of thickness in a case of changing the content of each marker element in the second magnetic layer in a perpendicular magnetic recording medium according to the first embodiment.

FIG. 7 is a view showing compositions of sputtering targets used in the formation of a second magnetic layer in a perpendicular magnetic according to a second embodiment of the present invention.

FIG. 8 is a graph showing the result of evaluating the scratch resistance of a perpendicular magnetic recording medium according to the second embodiment.

FIG. 9 is a view showing the layer constitution of a perpendicular magnetic recording medium according to a third embodiment of the present invention.

FIG. 10 is a view showing compositions of sputtering targets used for forming respective layers of a perpendicular magnetic recording medium according to the third embodiment.

FIGS. 11(a) and 11(b) are graphs showing the result of evaluating the thickness for a second magnetic layer and a third magnetic layer in a perpendicular magnetic recording medium according to the third embodiment by a florescent X-ray method.

FIG. 12 is a view showing compositions of sputtering targets used for forming a second magnetic layer and a third magnetic layer in a perpendicular magnetic recording medium according to a fourth embodiment of the present invention.

FIGS. 13(a)-13(c) are graphs showing the result of evaluating the scratch resistance of a perpendicular magnetic recording medium according to the fourth embodiment.

FIG. 14 is a view showing compositions of sputtering targets used for forming respective layers in a perpendicular magnetic recording medium manufactured according to a fifth embodiment of the present invention.

FIG. 15 is a graph showing the result of evaluation for the thickness of the second magnetic layer in the perpendicular magnetic recording medium manufactured according to the fifth embodiment.

FIGS. 16(a) and 16(b) are graphs showing the result of evaluating the writing/reading characteristic of the perpendicular magnetic recording medium prepared according to the fifth embodiment.

FIG. 17 is a view showing compositions of sputtering targets used for forming respective layer in a perpendicular magnetic recording medium manufactured according to a sixth embodiment of the present invention.

FIGS. 18(a) and 18(b) are graphs showing the result of evaluating the thickness for a second magnetic layer and a third magnetic layer in the perpendicular magnetic recording medium prepared according to the sixth embodiment.

FIGS. 19(a) and 19(b) are graphs showing the result of evaluating the writing/reading characteristic of the perpendicular magnetic recording medium prepared according to the sixth embodiment.

### DETAILED DESCRIPTION OF THE INVENTION

Embodiments of the present invention relate to a perpendicular magnetic recording medium capable of recording a great amount of information, and a manufacturing method thereof.

The present inventors have studied variously on perpendicular magnetic layers in which a first Co—Cr—Pt alloy magnetic layer containing an oxide and a second Co—Cr—Pt alloy magnetic layer not containing an oxide, are stacked. As a result, it has been found that the writing/reading characteristic of the perpendicular magnetic recording medium having such a layer constitution greatly depends on the thickness of the second magnetic layer. For example, a magnetic core width (MCW) comprising a recording track width and an erase band increases as the thickness of the second magnetic layer increases. This means that data are recorded more easily by providing the second magnetic layer. Actually, the overwriting characteristic (O/W) as an index of easy recording is improved as the thickness of the second magnetic layer increases. On the other hand, the media SNR shows a trend of increase along with the increase in the thickness of the second magnetic layer and saturation at a certain thickness or more. In order to increase the longitudinal recording density, it is desirable to decrease the magnetic core width within a range capable of obtaining a desired media SNR and, for this purpose, it is necessary to control the thickness of the second magnetic layer with a high accuracy. Actually, in a case of mass production of such perpendicular magnetic recording media, it is considered essential to monitor the thickness of the second magnetic layer and compensate for the thickness at a certain interval within a lot as a unit of production so as to suppress the fluctuation of the read/write characteristics of media.

Another problem of the granular type perpendicular magnetic recording medium with addition of the oxide is that scratches tend to be generated more compared with a longitudinal magnetic recording medium upon contact with a head. As described above, in the granular perpendicular recording layer, non-magnetic oxides form grain boundaries so as to surround magnetic particles and it is considered that such a fine structure results in the degradation of the scratch resistance. Higher impact resistance is demanded for magnetic disk apparatus used in home information electronics products and the scratch resistance of the media becomes important more and more.

Embodiments of the present invention has been achieved in view of the foregoing situations. A first object according to certain embodiments of the invention is to provide a perpendicular magnetic recording medium suitable to suppression of the fluctuation of the reading/writing characteristic within the lot attributable to the thickness of the second magnetic layer, as well as a manufacturing method thereof upon mass production of a perpendicular magnetic recording medium having a perpendicular recording layer of a bi-layered structure in which a first Co—Cr—Pt alloy magnetic layer containing an oxide and a second Co—Cr—Pt magnetic layer are formed successively. A second object according to embodiments of the invention, in addition to the first object, is to provide a perpendicular magnetic recording medium of further improved scratch resistance and having high reliability.

In accordance with a perpendicular magnetic recording medium according to embodiments of the invention for attaining the foregoing object, a perpendicular magnetic recording layer is formed above a substrate by way of a soft magnetic underlayer, the perpendicular recording layer has a bi-layered structure in which a first Co—Cr—Pt alloy magnetic layer containing an oxide and a second Co—Cr—Pt alloy magnetic layer containing a marker element for measurement of a thickness selected from Mo, Mn, and V, and the content of the marker element for measurement of thickness is 1.5 at % or more and 5 at % or less.

The marker element for measurement of thickness is not contained in the layers other than the second magnetic layer and this is an element suitable to measurement of thickness by a fluorescence X-ray method. For example, in a case of selecting Mo as the marker element, the thickness is evaluated by the fluorescence X-ray method using Mo L-α. In this case, since there is no interference spectra by elements contained in other layers, measurement at high accuracy is possible with a content of 1.5 at % or more.

The marker element for measurement of thickness is an element mainly intended for the control of the thickness of the second Co—Cr—Pt alloy magnetic layer and giving not so large effect on the magnetic characteristic. For example, in a case where the content of the marker element is 3 at %, substantially the same magnetic characteristic is obtained by decreasing the concentration of Cr in the second Co—Cr—Pt alloy magnetic layer by an identical amount (3 at %). However, in a case where the content of the marker element increases to more than 5 at %, crystallinity of the second magnetic layer is deteriorated to increase the change of the magnetic characteristic, which is not desirable.

The main effect obtained by providing the second magnetic layer is to improve the writing/reading characteristic of the medium as described above. When the present inventors noted the scratch resistance as one of the subjects of the granular type perpendicular magnetic recording medium and investigated the effect of the second magnetic layer, it was determined that the second Co—Cr—Pt alloy magnetic layer according to embodiments of the invention containing the marker element for measurement of thickness selected from Mo, Mn, and V has an effect of improving the scratch resistance. Further, it has been found that the scratch resistance is further improved by adding B to the second magnetic layer. The B content is preferably 3 at % or more and 15 at % or less for obtaining a remarkable effect for improving the scratch resistance. In a case where the addition amount of B is more than 15 at %, this makes it difficult to manufacture a favorable sputtering target, which is not desirable.

Further, a method of manufacturing a perpendicular magnetic recording medium includes steps of measuring the thickness of the second magnetic layer by fluorescence X-ray intensity of a marker element contained in the second magnetic layer and suppressing the fluctuation of the film forming rate of the second magnetic layer based on the thickness data.

Another perpendicular magnetic recording medium according to embodiments of the invention, has a feature in that a perpendicular recording layer is formed by way of a soft magnetic underlayer above a substrate, a perpendicular recording layer has a tri-layered structure in which a first Co—Cr—Pt alloy magnetic layer containing an oxide, a second Co—Cr alloy magnetic layer containing a marker element for measurement of thickness selected from Mo, Mn, and V, and a third Co—Cr—Pt alloy magnetic layer containing a marker element for measurement of thickness selected from Mo, Mn, and V, the content of each of the marker elements for measurement of thickness contained in the second magnetic layer and the third magnetic layer is 1.5 at % or more and 5 at % or less, and the marker element for measurement of thickness contained in the second magnetic layer, and the marker element for measurement of thickness contained in the third magnetic layer are different.

The marker element for measurement of thickness is an element not contained in the layers other than the second magnetic layer and the third magnetic layer and suitable to measurement of thickness by the fluorescence X-ray method. For example, in a case of selecting V as the marker element contained in the second magnetic layer and selecting Mn as the marker element contained in the third magnetic layer, the thickness is evaluated by the fluorescence X-ray method using V K-α and Mn K-α. In this case, since there are no interference spectra by elements contained in other layers, measurement at a high accuracy is possible with the content of 1.5 at % or more.

The marker element for measurement of thickness is an element mainly intended for the control of the thickness of the second Co—Cr alloy magnetic layer and the third Co—Cr—Pt alloy magnetic layer and giving not so large effect on the magnetic characteristic of both layers. For example, in a case where the content of each marker element is 3 at %, substantially the same magnetic characteristic is obtained by decreasing the concentration of Cr in the second Co—Cr—Pt alloy magnetic layer and the third Co—Cr—Pt alloy magnetic layer by an identical amount (3 at %). However, in a case where the content of each marker element increases to more than 5 at %, crystallinity of the second magnetic layer and the third magnetic layer is deteriorated to increase the change of the magnetic characteristic, which is not desirable.

The scratch resistance is improved by adding B to at least one layer of the second magnetic layer and the third magnetic layer. The content of B is preferably 3 at % or more and 15 at % or less for obtaining a remarkable effect for improving the scratch resistance. In a case where the content of B is more than 15 at %, this makes it difficult to manufacture a favorable sputtering target, which is not desirable.

Further, the method of manufacturing the perpendicular magnetic recording medium includes steps of measuring the thickness of the second magnetic layer by fluorescence X-ray intensity of a marker element contained in the second magnetic layer and suppressing the fluctuation of the film forming rate based on the thickness data and a step of controlling the thickness of the third magnetic layer by the fluorescence X-ray intensity of a marker element contained in the third magnetic layer and suppressing the fluctuation of the film forming rate based on the thickness data.

According to embodiments of the invention, since the thickness of the second magnetic layer can be controlled at an accuracy of ±0.2 nm or less upon mass production of perpendicular magnetic recording media having the perpendicular recording layer in a bi-layered structure in which the first Co—Cr—Pt alloy magnetic layer containing the oxide and the second Co—Cr—Pt alloy magnetic layer are formed successively, fluctuation of the reading/writing characteristic within a lot can be suppressed. Further, since the scratch resistance can be improved compared with the perpendicular magnetic recording medium having the granular type perpendicular recording layer, it is possible to provide a perpendicular recording medium capable of high density recording and having high reliability.

A perpendicular magnetic recording medium and a manufacturing method thereof according to embodiments of the invention are to be described specifically with reference to the drawings.

### FIRST EMBODIMENT

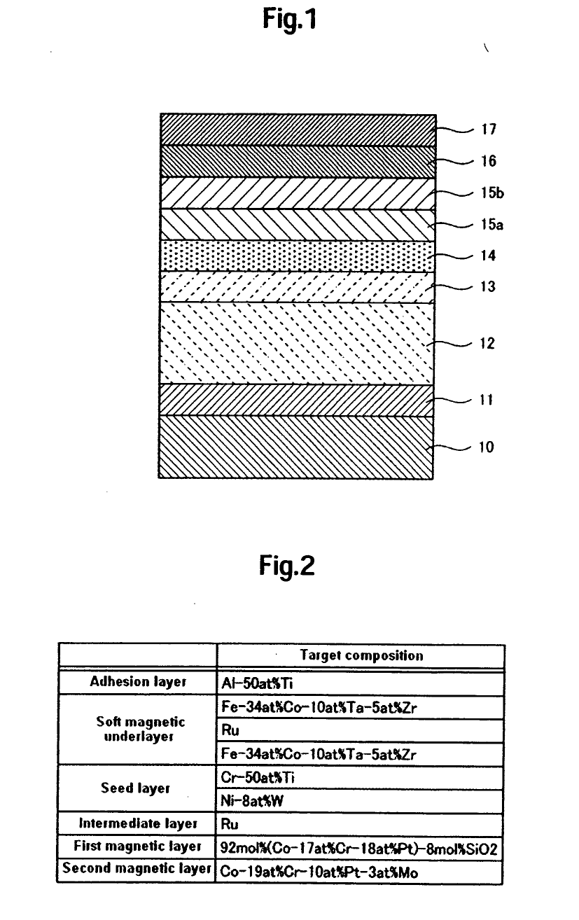

FIG. 1 is a view showing a layer constitution of a perpendicular magnetic recording medium according to a first embodiment of the invention. In the perpendicular magnetic recording medium, an adhesion layer 11, a soft magnetic underlayer 12, a seed layer 13, an intermediate layer 14, a perpendicular recording layer 15 (15a, 15b), a protective layer 16, and a lubricating layer 17 are successively formed on the substrate 10. The perpendicular recording layer 15 comprises a first magnetic layer 15a and a second magnetic layer 15b. The perpendicular magnetic recording medium of this embodiment was manufactured by using a sputtering apparatus (C-3040) manufactured by Canon Anelva Co. For the substrate 10, a glass substrate of 48 mm outer diameter and 0.508 mm thickness was used. As the adhesive layer 11, an Al—Ti alloy film of 5 nm thickness was formed. As the soft magnetic underlayer 12, a film was formed by stacking two Fe—Co—Ta—Zr alloy films each of 30 mm thickness through an Ru film of 0.4 mm. As the seed layer 13, a stacked film comprising a Cr—Ti alloy film of 2 nm thickness and an Ni—W alloy film of 7 nm thickness was formed. As the intermediate layer 14, an Ru film of 17 nm thickness was formed. As the first magnetic layer 15a, a Co—Cr—Pt—SiO₂ alloy film of 11.5 nm to 14.5 nm thickness was formed, as the second magnetic layer 15b, a Co—Cr—Pt—Mo alloy film of 6 nm to 10 mm thickness not containing an oxide was formed, and, as the protective layer 16, a carbon film of 4 nm thickness was formed. In this case, the first magnetic layer 15a was formed in a gas mixture of argon and oxygen by a reactive sputtering method, and the protective layer 16 was formed by an RF-CVD method. As the lubrication layer 17, a perfluoroalkyl polyether material was coated. FIG. 2 shows compositions for sputtering targets used for forming each of the layers.

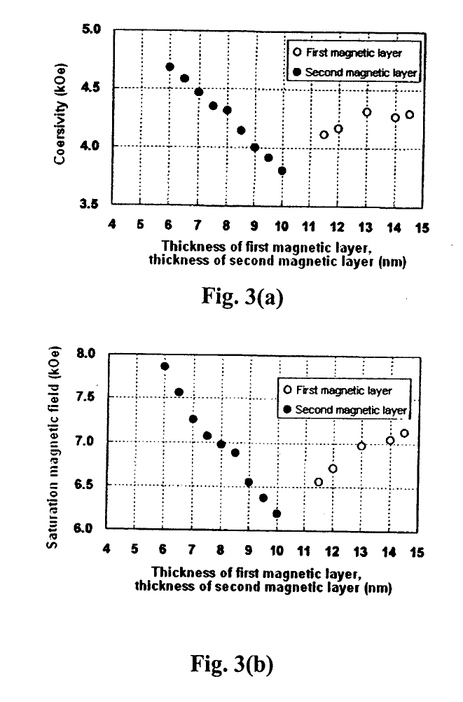

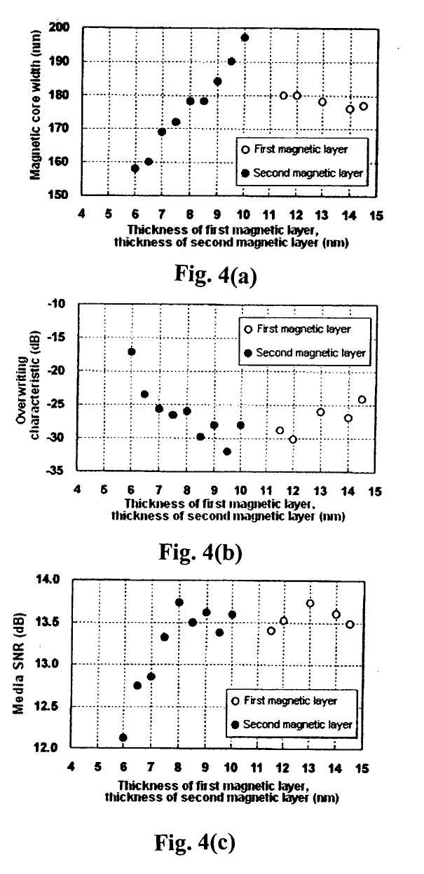

FIGS. 3(a) and 3(b) are graphs showing the magnetic characteristic of the perpendicular recording layer according to the first embodiment. The coersivity (Hc) and the saturation magnetic field (Hs) decrease greatly with increasing the thickness of the second magnetic layer 15b. On the other hand, for the first magnetic layer 15a, while Hc and Hs tend to increase along with the thickness thereof, the amount of change is small. FIGS. 4(a)-4(c) are graphs showing the writing/reading characteristic of the perpendicular magnetic recording medium of the first embodiment. Corresponding to the change of the magnetic characteristic of the perpendicular recording layer, the magnetic core width (MCW) increases with increasing the thickness of the second magnetic layer 15b and the overwriting characteristic (O/W) is improved. Further, the media SNR is improved with increasing the thickness of the second magnetic layer 15b and shows a saturation tendency in a region thicker than 8 nm. On the other hand, while a trend that MCW decreases with increasing the thickness and O/W is deteriorated is observed, the amount of change is small. From the results described above, it can be seen that the thickness of the second magnetic layer 15b constituting the perpendicular recording layer has to be controlled at a good accuracy in order to obtain a desired writing/reading characteristic.

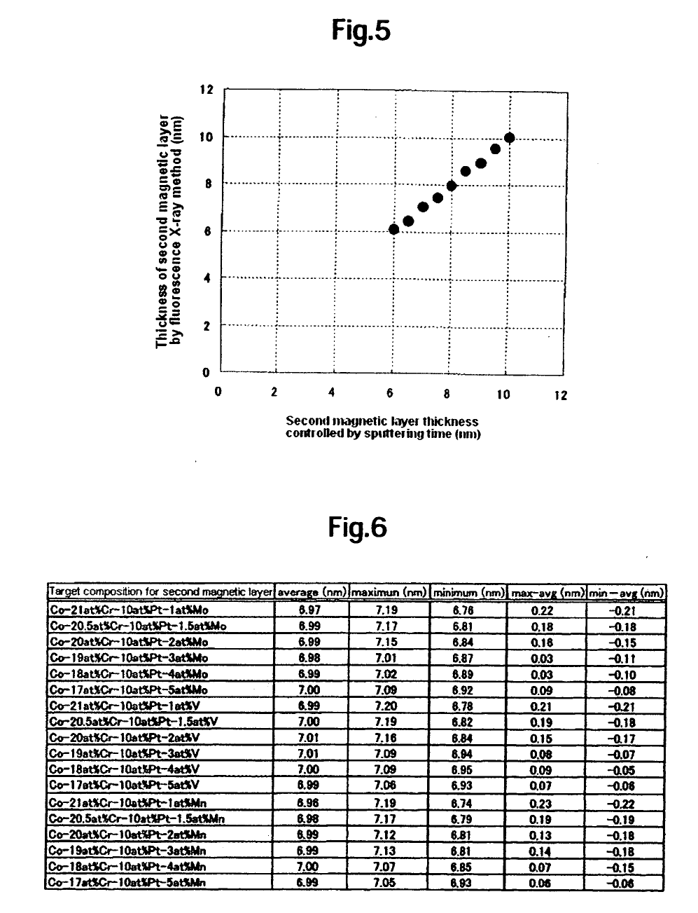

FIG. 5 shows the result of evaluating the thickness of the second magnetic layer 15b in the perpendicular magnetic recording medium of the first embodiment by a fluorescent X-ray method (using fluorescent ray apparatus: W/D-A3640 manufactured by Rigaku Co.). To measure the spectrum of fluorescent X-rays, Mo-Lα not undergoing the interference spectra from other layers was used. The abscissa indicates the thickness of the second magnetic layer controlled by determining a film forming rate of the second magnetic layer by an X-ray reflection method and based on the sputtering time, while the ordinate indicates the thickness of the second magnetic layer determined by previously preparing a calibration curve for a fluorescent X-ray method by using the thickness data determined by an X-ray reflectance method and determined based on the calibration curve. A linear relation is established between the thickness of the second magnetic layer 15b controlled by the sputtering time and the thickness of the second magnetic layer 15b evaluated by the fluorescence X-ray method showing that 3 at % of Mo added to the second magnetic layer 15b is useful for measurement of thickness of the second magnetic layer.

Then, to evaluate the lower limit of the content of the marker element (Mo, V, Mn) for measurement of thickness of the second magnetic layer 15b, the reproducibility was evaluated in a case of changing the content of each marker element from 1 at to 5 at %. The number of measurement for each sample was 20. As the spectra of fluorescence X-rays, Mo-Lα, V—Kα, and Mn—Kα were used respectively. As shown in FIG. 6, it can be seen that the thickness of the second magnetic layer 15b can be evaluated at an accuracy of ±0.2 nm or less in a case where the content is 1.5 at % or more irrespective of the kind of the marker element.

According to the first embodiment, since the thickness of the second magnetic layer can be controlled at an accuracy of ±0.2 nm or less upon mass production of perpendicular magnetic recording media having a perpendicular recording layer of a bi-layered structure in which the first Co—Cr—Pt alloy magnetic layer containing the oxide and the second Co—Cr—Pt alloy magnetic layer not containing the oxide are formed successively, fluctuation of the writing/reading characteristic within a lot can be suppressed.

### SECOND EMBODIMENT

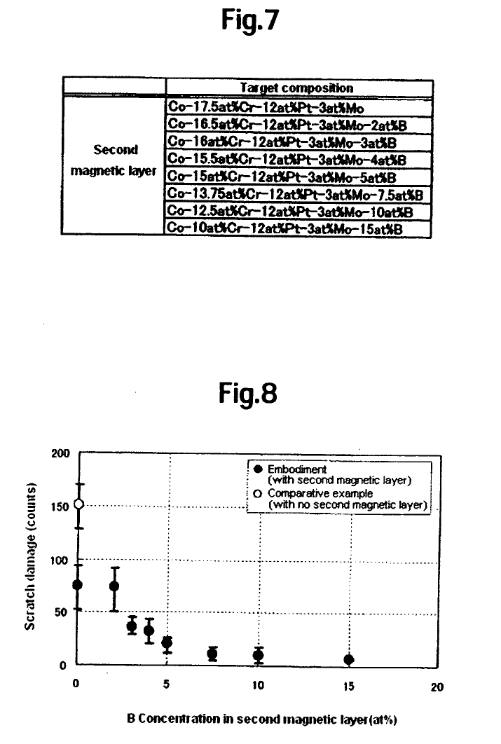

A perpendicular magnetic recording medium was manufactured in the same procedures as those for the first embodiment. As the second magnetic layer 15b, a Co—Cr—Pt—Mo alloy film of 7 nm thickness and a Co—Cr—Pt—Mo—B alloy film with the concentration B being changed from 2 at % to 15 at % were used. Other layers are identical with those in the first embodiment. FIG. 7 shows compositions of sputtering targets used for forming the second magnetic layer 15b. Further, as a comparative example, a medium not forming the second layer 15b but forming the protective layer 16 directly on the first magnetic layer 15a was manufactured.

To evaluate the scratch resistance of the perpendicular magnetic recording media according to a second embodiment of the present invention and the comparative example, a scratch damage test of applying a ramp load system was conducted. In this case, the scratch damage test is a test of colliding a magnetic head against a magnetic recording medium during rotation by plural times by a ramp load to apply scratch-like damage on the magnetic disk. In this test, to apply damage of the magnetic recording medium in a short time under acceleration, the ramp load speed was set 20 times as high as the actual speed in a magnetic disk apparatus. For the test apparatus, HDI Reliability Tester manufactured by CENTER FOR TRIBOLOGY Co. in U.S.A. having an actuator for holding a magnetic recording medium and moving a magnetic head in an arcuate trace, and a ramp (slide stand) to the outside of the outer end of the magnetic recording medium, and having a controlling function of sweeping the magnetic head between the ramp and the magnetic recording medium in an interlocking manner was used. The ramp load is, for example, “Load/Unload mechanism” described in “Modem Storage Terminology”, 293 p, published from Nikkei BP Co.

After the scratch damage test, scratches on the surface of the magnetic recording medium were detected and the number of scratches was counted and analyzed. In the scratch damaged portion, the thickness of the protective film on the magnetic recording medium is reduced or eliminated. This was imaged by a laser ellipsometry method and the number of scratches was calculated by image processing. For the counting and the analysis of the scratches, Candela Optical Surface Analyzer (Model 6120) manufactured by KLA TENCOR CO. in U.S.A. was used.

FIG. 8 shows a result of evaluating the scratch resistance of perpendicular magnetic recording media of the second embodiment and the comparative example. In a case of not forming the second magnetic layer 15b (Comparative Example), the number of the scratches was as large as about 150 and the scratch resistance was insufficient. In a medium of forming the Co—Cr—Pt—Mo alloy film as the second magnetic layer 15b, the number of scratches was reduced to one-half as about by the number of 75 and improvement was observed for the scratch resistance. On the other hand, in a medium forming the Co—Cr—Pt—Mo—B alloy film as the second magnetic layer 15b, the average number of scratches was reduced to 36 in a case of adding B at a concentration of 3 at %, and improvement in the scratch resistance was observed compared with the case of forming the Co—Mo—Pt—Mo alloy film. Further, in a case of adding B at a concentration of 5 at % or more, extremely favorable scratch resistance with the average number of scratches as about 20 was obtained. From the result described above, it was found that the scratch resistance was improved by forming the second magnetic layer 15b and, further, a more preferred scratch resistance was obtained by adding B at 3 at % or more to the second magnetic layer 15b.

According to the second embodiment, since the scratch resistance is improved further in addition to the effect of the first embodiment, a perpendicular recording medium capable of high density recording and having high reliability can be provided.

### THIRD EMBODIMENT

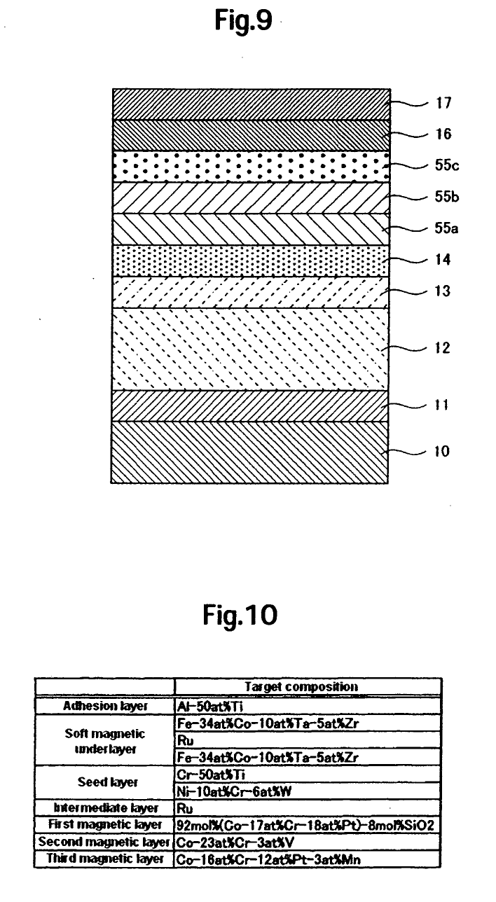

FIG. 9 is a view showing the layer constitution of a perpendicular magnetic recording medium according to a third embodiment of the present invention. In the perpendicular magnetic recording medium, an adhesion layer 11, a soft magnetic underlayer 12, a seed layer 13, and an intermediate layer 14, a perpendicular recording layer 55 (55a, 55b, 55c), a protective layer 16, and a lubrication layer 17 are successively formed on a substrate 10. The perpendicular recording layer 55 is constituted with a first magnetic layer 55a, a second magnetic layer 55b, and a third magnetic layer 55c. The manufacturing method for the medium was conducted in the same procedures as those in the first embodiment. A Co—Cr—Pt—SiO₂ alloy film of 13 nm thickness was formed as the first magnetic layer 55a, a Co—Cr—V film of 1 nm to 5 nm thickness not containing an oxide was formed as the second magnetic layer 55b, and a Co—Cr—Pt—Mn film of 4 nm to 7 nm thickness not containing an oxide was formed as the third magnetic layer 55c. Other layers are identical with those in the first embodiment. FIG. 10 shows compositions of sputtering targets used for forming respective layers.

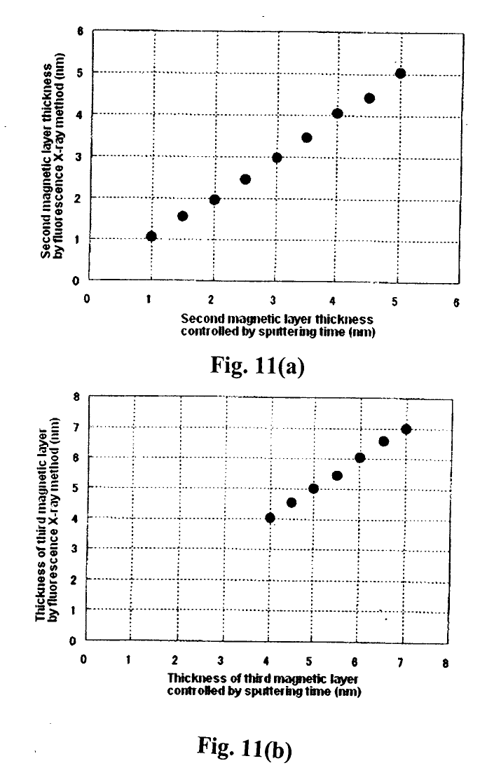

FIGS. 11(a) and 11(b) show the result of evaluating the thickness of the second magnetic layer 55b and the third magnetic layer 55c in the perpendicular magnetic recording medium of the third embodiment by a fluorescent X-ray method. For the measuring spectrum of fluorescent X-rays, V—Kα and Mn—Kα were used. The abscissa indicates the thickness of the second magnetic layer and the third magnetic layer controlled by determining a film forming rate of the second magnetic layer and the third magnetic layer by an X-ray reflection method and based on the sputtering time, while the ordinate indicates the thickness of the second magnetic layer and the third magnetic layer determined by previously preparing a calibration curve for a fluorescent X-ray method by using the thickness data determined by the X-ray reflectance method and based on the calibration curve. Linear relations are established between the thickness of the second magnetic layer 55b and the third magnetic layer 55c controlled by the sputtering time and the thickness of the second magnetic layer 55b and the third magnetic layer 55c evaluated by the fluorescence X-ray method, showing that 3 at % of V added to the second magnetic layer 55b and 3 at % of Mn added to the third magnetic layer 55c are useful for the measurement of the thickness of the second magnetic layer 55b and the third magnetic layer 55c, respectively.

### FOURTH EMBODIMENT

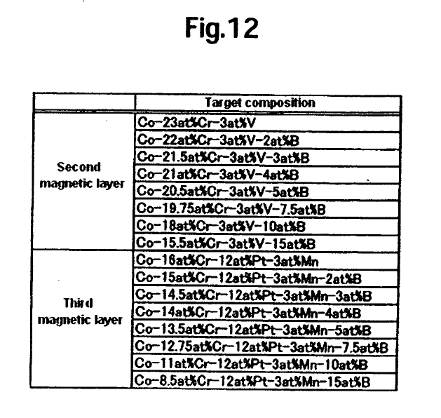

A perpendicular magnetic recording medium was manufactured in the same manner as those in the third embodiment. A Co—Cr—V film of 2 nm thickness and a Co—Cr—V—B alloy film with the B concentration being changed from 2 at % to 15 at % were used as the second magnetic layer 55b. A Co—Cr—Pt—Mn film of 5 nm thickness and a Co—Cr—Pt—Mn—B alloy film with the B concentration being changed from 2 at % to 15 at % were used as the third magnetic layer 55c. Other layers are identical with those in the third embodiment. FIG. 12 shows compositions of sputtering targets used in the formation of the second magnetic layer 55b and the third magnetic layer 55c.

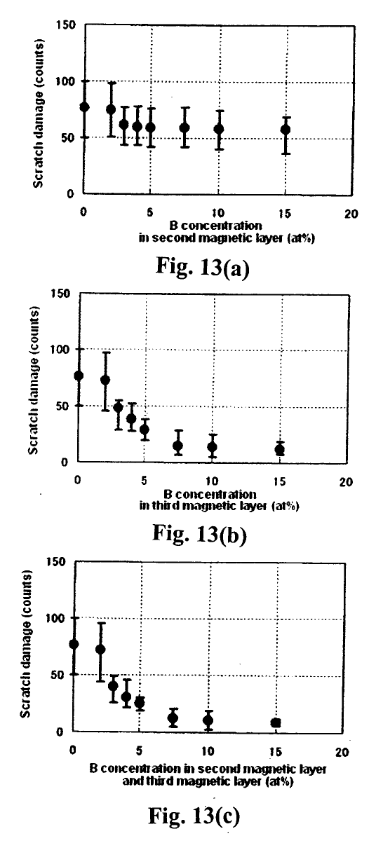

The scratch resistance of the perpendicular magnetic recording medium according to a fourth embodiment was evaluated by the same procedures as those in the second embodiment. FIG. 13(a) shows the result of adding B only to the second magnetic layer 55b and using a Co—Cr—Pt—Mn film to the third magnetic layer 55c, FIG. 13(b) shows a result of adding B only to the third magnetic layer 55c and using a Co—Cr—V film for the second magnetic layer 55b, and FIG. 13(c) shows the result of adding B to both of the second magnetic layer 55b and the third magnetic layer 55c respectively. Each of the cases shows a trend that the average number of scratches is decreased in a case of adding B at 3 at % or more, and it was found that addition of B to the second magnetic layer 55b and the third magnetic layer 55c is effective for the improvement of the scratch resistance.

### FIFTH EMBODIMENT

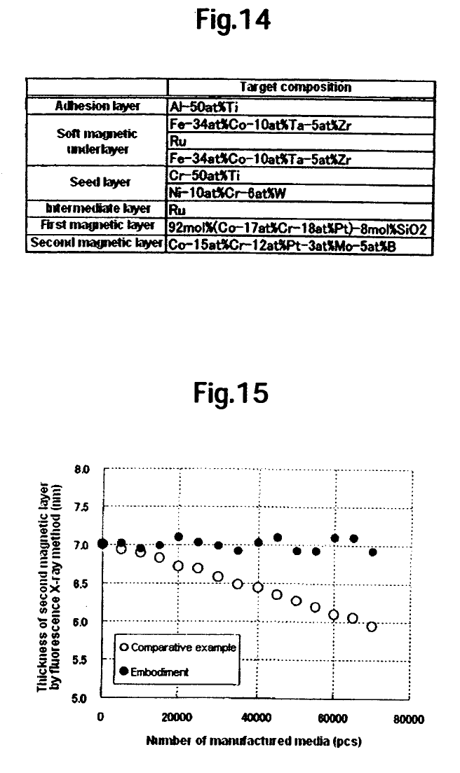

A fifth embodiment is a method of manufacturing a perpendicular recording medium of the first embodiment. A perpendicular magnetic recording medium was manufactured in the same procedures as those in the first embodiment. A Co—Cr—Pt—SiO₂ alloy film of 13 nm thickness was used as the first magnetic layer 15a, and a Co—Cr—Pt—Mo—B alloy film of 7 nm thickness was used as the second magnetic layer 15b. Other layers are identical with those in the first embodiment. FIG. 14 shows compositions of sputtering targets used for forming respective layers. In the fifth embodiment, perpendicular magnetic recording media were manufactured by 70,000 disks continuously, and fluctuation of the writing/reading characteristic within a lot was evaluated. In this case, a step of measuring the thickness of the second magnetic layer 15b by the fluorescence X-ray method in the same manner as in the first embodiment at a pitch of 5,000 disks and controlling the power charged for sputtering based on the thickness data was provided. Further, as a comparative example, 70,000 disks of media were manufactured continuously at a constant sputtering power without providing the step of controlling the sputtering power.

FIG. 15 shows the result of evaluating the thickness of the second magnetic layer 15b in the perpendicular magnetic recording media manufactured by the fifth embodiment and the perpendicular magnetic recording media manufactured by comparative example by a fluorescence X-ray method. In the comparative example in which the sputtering power was controlled constant, thickness of the second magnetic layer 15b decreased moderately along with the number of media manufactured and it was decreased by about 15% between the beginning and the end of the lot. On the other hand, the fifth embodiment for suppressing the fluctuation of the film forming rate by controlling the sputtering power, the fluctuation of the thickness for the second magnetic layer 15b was +3% or less.

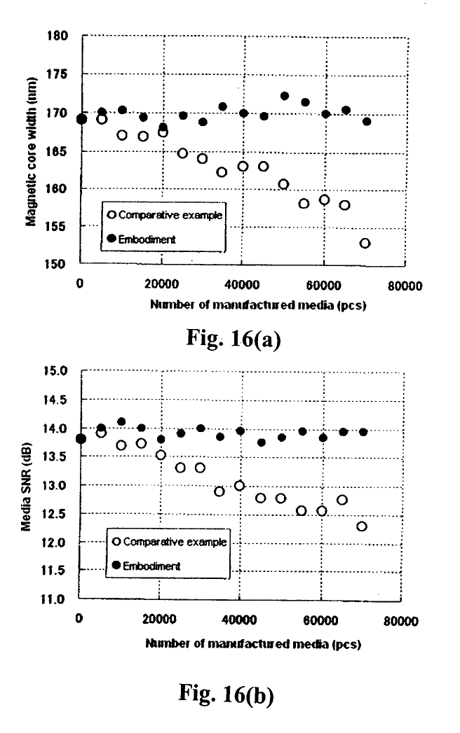

FIGS. 16(a) and 16(b) show the result of evaluating the writing/reading characteristic of perpendicular magnetic recording media manufactured according to the fifth embodiment and the perpendicular magnetic recording media manufactured by a comparative example. In the comparative example, MCW was decreased and the media SNR was deteriorated in the latter half of the lot, whereas in the fifth embodiment, fluctuation within the lot was ±3% or less both for MCW and the media SNR and a stable writing/reading characteristic was obtained. This is considered that fluctuation of the thickness of the second magnetic layer 15b giving a significant effect on the writing/reading characteristic could be suppressed in the fifth embodiment. As described above, it was found that control for the thickness of the second magnetic layer 15b by the fluorescence X-ray method greatly contributed to suppression for the fluctuation of the reading/writing characteristic of the media in view of mass production of the perpendicular magnetic recording medium having a perpendicular recording layer of a bi-layered structure in which the first Co—Cr—Pt alloy magnetic layer 15a containing the oxide, and the second Co—Cr—Pt alloy magnetic layer 15b are formed successively.

### SIXTH EMBODIMENT

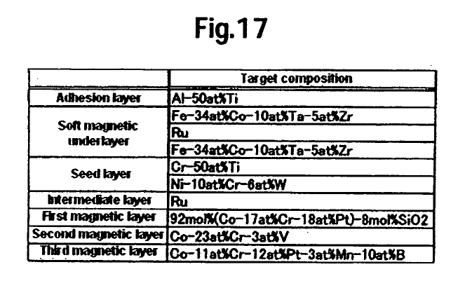

A perpendicular magnetic recording medium was manufactured in the same procedures as those in the fourth embodiment. A Co—Cr—V film of 2 nm thickness was used as the second magnetic layer 55b, and a Co—Cr—Pt—Mn—B alloy film of 5 nm thickness was used as the third magnetic layer 55c. Other materials are identical with those in the fourth embodiment. FIG. 17 shows compositions of sputtering targets used for forming respective layers. In a sixth embodiment, perpendicular magnetic recording media were manufactured continually by 70,000 disks, and the fluctuation of the writing/reading characteristic was evaluated. In this case, a step of measuring the thickness of the second magnetic layer 55b and the third magnetic layer 55c by the fluorescent X-ray method in the same manner as in the third embodiment at a pitch of 5,000 sheets and controlling the charged power in sputtering based on the thickness data was provided. Further, as the comparative example, 70,000 disks of media were manufactured continuously with the sputtering power being constant, without providing the step of controlling the sputtering power as the comparative example.

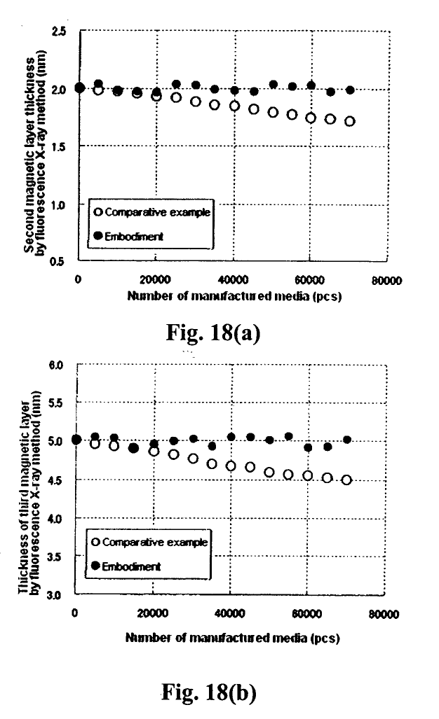

FIGS. 18(a) and 18(b) show the result of evaluating the thickness for the second magnetic layer 55b and the third magnetic layer 55c of the perpendicular magnetic recording medium manufactured by the sixth embodiment and the perpendicular magnetic recording medium manufactured by the comparative example by the fluorescence X-ray method. In the comparative example in which the sputtering power was set constant, the thicknesses of the second magnetic layer 55b and the third magnetic layer 55c were decreased moderately with increasing the number of media manufactured and the thicknesses were decreased by about 10% and about 14% between the beginning and the end of the lot, respectively. On the other hand, in the sixth embodiment where the fluctuation of the film forming rate was suppressed by controlling the sputtering power, the fluctuation of the thickness for the second magnetic layer 55b and the third magnetic layer 55c was +3% or less.

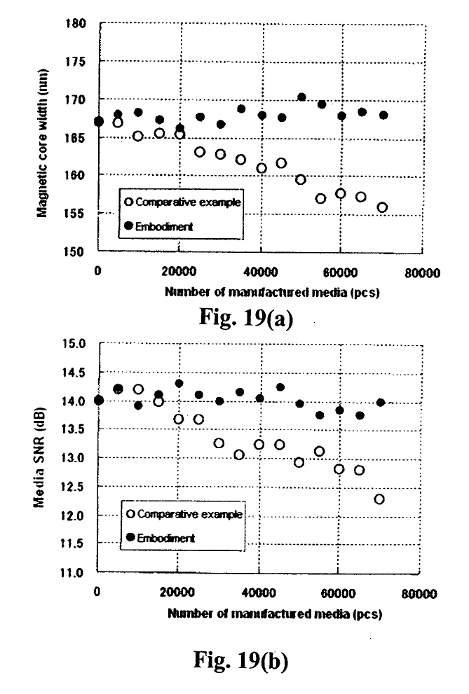

FIGS. 19(a) and 19(b) show the result of evaluating the writing/reading characteristic of the perpendicular magnetic recording medium manufactured by the sixth embodiment and the perpendicular magnetic recording medium manufactured by a comparative example. In the comparative example, MCW was decreased and the media SNR was degraded in the latter half of the lot, whereas fluctuation was ±3% or less within the lot both for MCW and media SNR and stable writing/reading characteristic was obtained in the sixth embodiment. It is considered that this is attributable that the fluctuation of the film thickness for the second magnetic layer 55b and the third magnetic layer 55c giving significant effect on the writing/reading characteristics could be suppressed in the sixth embodiment. It was found that control of the thickness for the second magnetic layer 55b and the third magnetic layer 55c by the fluorescence X-ray method greatly contributed to the suppression for the fluctuation of the writing/reading characteristic of the media in mass production of perpendicular magnetic recording media having a perpendicular recording layer of a tri-layered structure in which the first Co—Cr—Pt alloy magnetic layer 55a containing the oxide, the second Co—Cr alloy magnetic layer 55b not containing the oxide, and the third Co—Cr—Pt alloy magnetic layer 55c are formed successively.

What is claimed is:

1. A perpendicular magnetic recording medium comprising:
a substrate;
a soft magnetic underlayer formed above the substrate; and
a perpendicular recording layer formed above the soft magnetic underlayer;
wherein the perpendicular recording layer has a bi-layered structure in which a first Co—Cr—Pt alloy magnetic layer comprises an oxide and a second Co—Cr—Pt alloy magnetic layer comprises a marker element for measurement of a thickness selected from Mo, Mn, and V; and
the content of the marker element for measurement of a thickness is 1.5 at % or more and 5 at % or less.

2. The perpendicular magnetic recording medium according to claim 1, wherein the first Co—Cr—Pt alloy magnetic layer is under the second Co—Cr—Pt alloy magnetic layer.

3. The perpendicular magnetic recording medium according to claim 1, wherein the oxide is SiO₂.

4. The perpendicular magnetic recording medium according to claim 3, wherein the first Co—Cr—Pt alloy magnetic layer is under the second Co—Cr—Pt alloy magnetic layer.

5. The perpendicular magnetic recording medium according to claim 1, wherein the second magnetic layer does not contain an oxide.

6. The perpendicular magnetic recording medium according to claim 5, wherein the first Co—Cr—Pt alloy magnetic layer is under the second Co—Cr—Pt alloy magnetic layer.

7. The perpendicular magnetic recording medium according to claim 1, wherein B is contained in the second magnetic layer, and the content of B is 3 about at % or more and about 15 at % or less.

8. The perpendicular magnetic recording medium according to claim 7, wherein the first Co—Cr—Pt alloy magnetic layer is under the second Co—Cr—Pt alloy magnetic layer.

9. A perpendicular magnetic recording medium comprising:
a substrate;
a soft magnetic underlayer formed above the substrate; and
a perpendicular recording layer formed above the soft magnetic underlayer;
wherein the perpendicular recording layer has a tri-layered structure in which a first Co—Cr—Pt alloy magnetic layer comprises an oxide, a second Co—Cr alloy magnetic layer comprises a marker element for measurement of a thickness selected from Mo, Mn, and V, and a third Co—Cr—Pt alloy magnetic layer comprises a marker element for measurement of a thickness selected from Mo, Mn, and V are stacked successively; and
wherein the content of each of the marker elements for measurement of a thickness contained in the second magnetic layer and the third magnetic layer is about 1.5 at % or more and about 5 at % or less, and the marker element for measurement of a thickness contained in the second magnetic layer and the marker element for measurement of a thickness contained in the third magnetic layer are different from each other.

10. The perpendicular magnetic recording medium according to claim 9, wherein the first Co—Cr—Pt alloy magnetic layer is under the second Co—Cr—Pt alloy magnetic layer.

11. The perpendicular magnetic recording medium according to claim 9, wherein the oxide is SiO₂.

12. The perpendicular magnetic recording medium according to claim 11, wherein the first Co—Cr—Pt alloy magnetic layer is under the second Co—Cr—Pt alloy magnetic layer.

13. The perpendicular magnetic recording medium according to claim 9, wherein the second magnetic layer and the third magnetic layer do not contain an oxide.

14. The perpendicular magnetic recording medium according to claim 13, wherein the first Co—Cr—Pt alloy magnetic layer is under the second Co—Cr—Pt alloy magnetic layer.

15. A perpendicular magnetic recording medium comprising:
a substrate;
a soft magnetic underlayer formed above the substrate; and
a perpendicular recording layer formed above the soft magnetic underlayer;
wherein the perpendicular recording layer has a three-layered structure in which a first Co—Cr—Pt alloy magnetic layer comprises an oxide, a second Co—Cr alloy magnetic layer comprises a marker element for measurement of a thickness selected from Mo, Mn, and V, and a third Co—Cr—Pt alloy magnetic layer comprises a marker element for measurement of a thickness selected from Mo, Mn, and V;
wherein the content of each of the marker elements for measurement of a thickness contained in the second magnetic layer and the third magnetic layer is about 1.5 at % or more and about 5 at % or less, and the marker element for measurement of a thickness contained in the second magnetic layer and the marker element for measurement of a thickness contained in the third magnetic layer are different from each other; and
wherein B is contained in at least one layer of the second magnetic layer and the third magnetic layer, and the content of B is about 3 at % or more and about 15 at % or less.

16. The perpendicular magnetic recording medium according to claim 15, wherein the first Co—Cr—Pt alloy magnetic layer is under the second Co—Cr—Pt alloy magnetic layer.

17. The perpendicular magnetic recording medium according to claim 15, wherein B of about 3 at % or more and about 15 at % or less is contained in the second magnetic layer.

18. The perpendicular magnetic recording medium according to claim 17, wherein the first Co—Cr—Pt alloy magnetic layer is under the second Co—Cr—Pt alloy magnetic layer.

19. The perpendicular magnetic recording medium according to claim 15, wherein B of about 3 at % or more and about 15 at % or less is contained in the third magnetic layer.

20. The perpendicular magnetic recording medium according to claim 19, wherein the first Co—Cr—Pt alloy magnetic layer is under the second Co—Cr—Pt alloy magnetic layer.

21. The perpendicular magnetic recording medium according to claim 15, wherein B of about 3 at % or more and about 15 at % or less is contained in the second magnetic layer and the third magnetic layer.

22. A method of manufacturing a perpendicular magnetic recording medium having a substrate, a soft magnetic underlayer formed above the substrate, and a perpendicular recording layer formed above a soft magnetic underlayer, the method comprising the steps of;
forming the soft magnetic underlayer above the substrate via an adhesive layer;
forming a first Co—Cr—Pt alloy magnetic layer containing an oxide above the soft magnetic underlayer via an intermediate layer; and
forming a second Co—Cr—Pt alloy magnetic layer containing a marker element for measurement of a thickness selected from Mo, Mn, and V on the first magnetic layer;
wherein the step of forming the second magnetic layer includes a step of measuring the thickness for the second magnetic layer based on a fluorescence X-ray intensity of the marker element for measurement of a thickness contained in the second magnetic layer and controlling a film formation rate of the second magnetic layer based on the result of the measurement.

23. The method of manufacturing a perpendicular magnetic recording medium according to claim 22,
wherein the step of forming the second magnetic layer is performed by sputtering, and the step of controlling the film formation rate is to control a power charged in sputtering for forming the second magnetic layer.

24. The method of manufacturing a perpendicular magnetic recording medium according to claim 22,
wherein the content of the marker element for measurement of a thickness contained in the second magnetic layer is about 1.5 at % or more and about 5 at % or less.

25. The method of manufacturing a perpendicular magnetic recording medium according to claim 22, the method further comprising a step of forming a Co—Cr alloy magnetic layer containing a marker element for measurement of a thickness selected from Mo, Mn, and V between the first magnetic layer and the second magnetic layer,
wherein the step of forming the Co—Cr alloy magnetic layer includes a step of measuring the thickness of the Co—Cr alloy magnetic layer based on a fluorescence X-ray intensity of the marker element for measurement of a thickness contained in the Co—Cr alloy magnetic layer and controlling the film formation rate of the Co—Cr alloy magnetic layer based on the result of measurement.
